(19) United States
(12) Patent Application Publication
(10) Pub. No.: US 2019/0049583 A1
(43) Pub. Date: Feb. 14, 2019

(54) ENCODING LIDAR SIGNALS TO AVOID INTERFERENCE

(71) Applicant: Intel Corporation, Santa Clara, CA (US)

(72) Inventor: Wei Xu, Folsom, CA (US)

(73) Assignee: Intel Corporation, Santa Clara, CA (US)

(21) Appl. No.: 15/855,479

(22) Filed: Dec. 27, 2017

(51) Int. Cl. G01S 17/32; H04L 1/00; G01S 7/48

(52) U.S. Cl. CPC G01S 17/325; G01S 7/4804; H04L 1/0042

(57) ABSTRACT

Methods and apparatus relating to encoding Light Detection And Ranging (LIDAR) signals to avoid interference are described. In an embodiment, encode logic encodes a plurality of light beam pulses prior to transmission of the plurality of light beam pulses from at least one light source towards an object. Memory stores encoding information indicative of a type of encoding to be applied to the plurality of light beam pulses. Each of the plurality of light beam pulses comprises one or more sub-pulses. The encode logic is able to cause a modification to at least one of the one or more sub-pulses to encode the plurality of light beam pulses. Other embodiments are also disclosed and claimed.

### FIELD

The present disclosure generally relates to the field of electronics. More particularly, an embodiment relates to encoding Light Detection And Ranging (LIDAR) signals to avoid interference.

### BACKGROUND

Autonomous driving promises a world where a vehicle can transport its passengers from point A to point B with ultimate safety and with minimal human intervention.

To achieve these goals, many sensors may be used. LIDAR is one of the most important amongst these sensors, in part, because LIDAR can ensure safety for autonomous driving vehicles. Namely, LIDAR can accurately measure ranges by utilizing light in the form of a pulsed laser.

Accordingly, any improvements to LIDAR applications can significantly benefit the autonomous driving progression.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a diagram of autonomous driving vehicles, according to an embodiment.

FIG. 2 illustrates a block diagram of a LIDAR system, according to an embodiment.

FIG. 3 illustrates encoding LIDAR signals with frequency hopping, according to an embodiment.

FIG. 4 illustrates encoding LIDAR signals with pulse width encoding, according to an embodiment.

FIG. 5 illustrates encoding LIDAR signals with frequency and pulse width encoding, according to an embodiment.

FIG. 6 illustrates a flow diagram of a method for encoding LIDAR signals, according to an embodiment.

FIG. 7 illustrates a flow diagram of a method for decoding reflected LIDAR signals, according to an embodiment.

FIGS. 8 and 9 illustrates block diagrams of embodiments of computing systems, which may be utilized in various embodiments discussed herein.

FIGS. 10 and 11 illustrate various components of processers in accordance with some embodiments.

FIG. 12 illustrates a machine learning software stack, according to an embodiment.

FIG. 13 illustrates training and deployment of a deep neural network.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As mentioned above, autonomous driving promises a safer world. Operations of autonomous vehicles is highly dependent on sensors. LIDAR is one of the most important sensors to ensure safety for autonomous driving. Currently, most of the test cases have only one car running on the road with LIDAR. However, when multiple autonomous vehicles with LIDAR drive closely to each other, it is possible that their LIDAR signals would interfere with each other and cause a false reaction/detection. This could pose a critical safety issue, e.g., when an object is falsely detected and/or the location of an object is incorrectly detected. In addition, hackers can potentially penetrate the system and use a laser emitter to simulate an object on the road, e.g. to simulate a car or another large object, causing the autonomous vehicle to stop or change course when the road way is in fact clear.

To this end, some embodiments relate to encoding LIDAR signals to avoid interference. In an embodiment, the encoding pattern of the LIDAR signals can be dynamically changed, e.g., automatically and/or be varied based on a selection (e.g., provided in accordance some user preference(s)). In some embodiments, frequency hopping, pulse width variation, wavelength modification, amplitude modification, phase shifting, or any combinations thereof can be used to enhance the encoding. Decoding may be performed via logic coupled to a LIDAR receiver as will be further discussed herein.

In an embodiment, the logic used to encode and/or decode the LIDAR pulses/signals is mounted or otherwise physically coupled to a vehicle. As discussed herein, “vehicle” generally refers to any transportation device capable of being operated autonomously (with little or no human/driver intervention), such as an automobile, a truck, a motorcycle, an airplane, a helicopter, a vessel/ship, etc. whether or not the vehicle is a passenger or commercial vehicle, and regardless of the power source type used to move the vehicle.

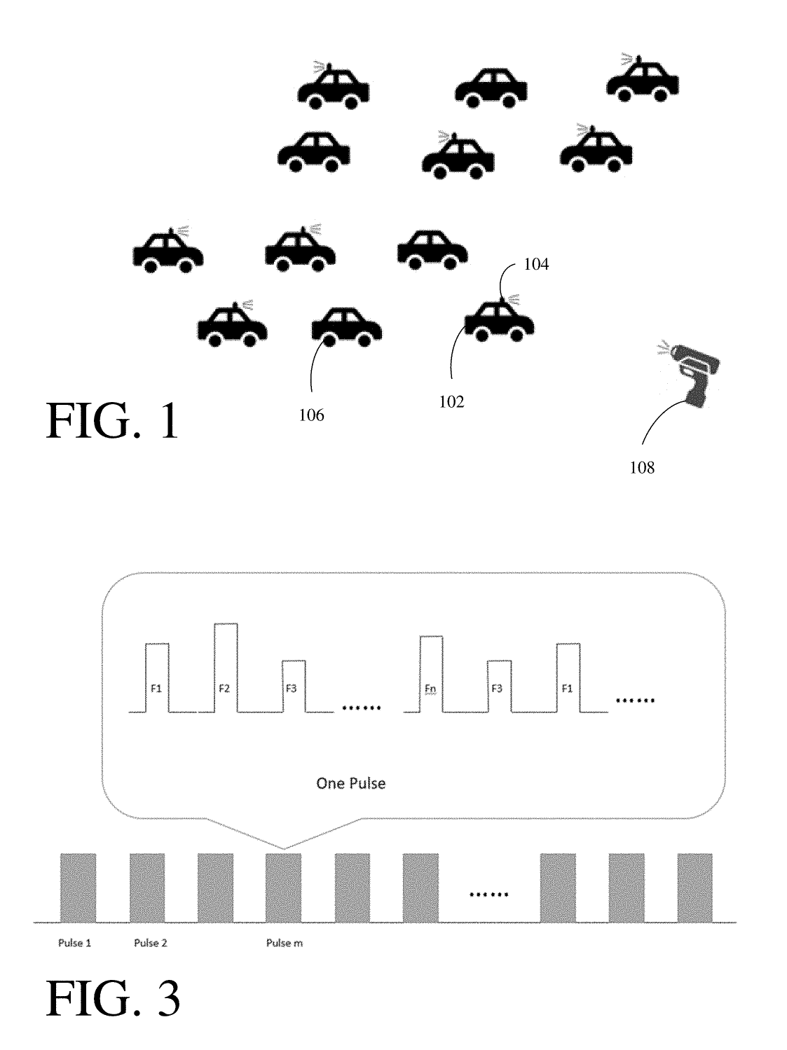

FIG. 1 illustrates a diagram of autonomous driving vehicles, according to an embodiment. As shown, several vehicles 102 with LIDAR 104 may drive within the same vicinity/area such that their LIDAR signals may interfere with each other and potentially cause a false reaction/detection. In this scenario, vehicles without LIDAR 106 may also be present in the same vicinity/area. The potential interference could pose a critical safety issue, e.g., when an object is falsely detected and/or the location of an object is incorrectly detected. In addition, hackers can potentially penetrate the system and use a laser emitter 108 to simulate an object on the road, e.g. to simulate a car or another large object, causing the autonomous vehicle to stop or change course when the road way is in fact clear.

As discussed herein, a “laser” generally refers to electromagnetic radiation that is spatially and temporally coherent. Also, while some embodiments are discussed with reference to laser beams, other types of electromagnetic beams capable of detecting ranges or obstacle detection can also be used such as ultrasound, infrared, or other types of beams.

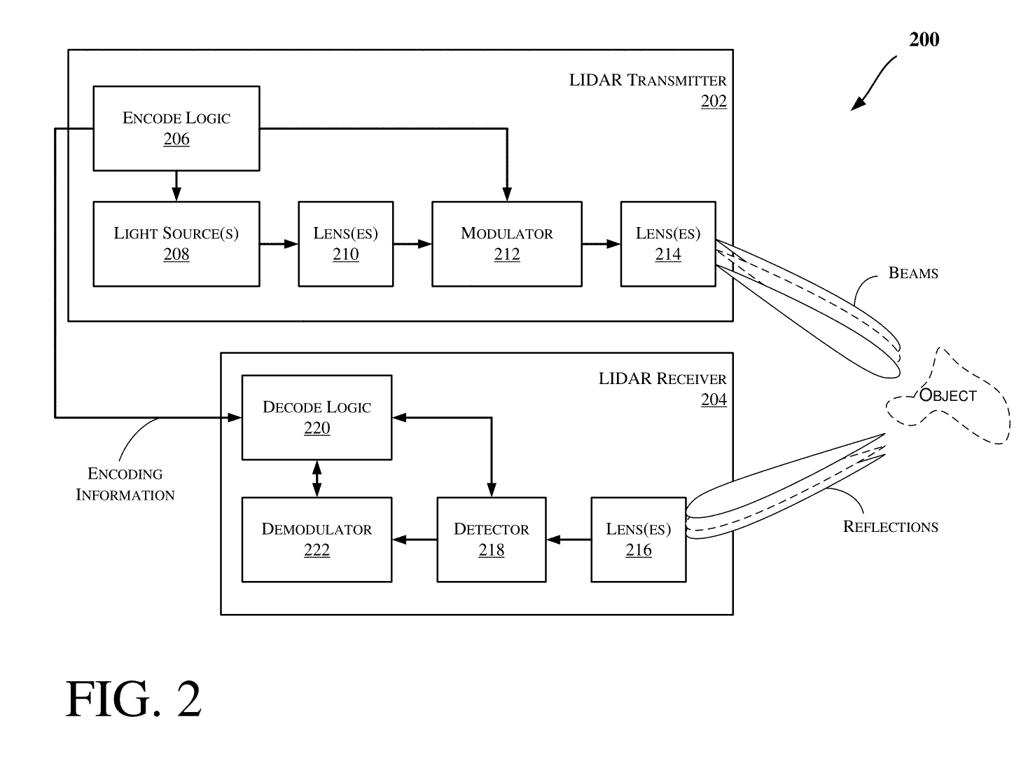

As will be further discussed herein (e.g., FIGS. 2-13), logic may be utilized to encode/decode the LIDAR signals to avoid (or at least partially reduce a chance) for such interference potential. This in turn would enhance safety for autonomous driving. LIDAR utilizes light beams in the form of a pulsed laser to measure ranges. In an embodiment, these laser pulses are encoded before the LIDAR device emits the pulses. On the LIDAR receiver side, the detected reflections are checked and matched per the encoding information. Only matched encoded signals will be accepted by the system, e.g., to ensure that there is no false detection corresponding to a detected object. This approach will avoid interference from other vehicles or devices that emit potentially interfering signals/beams.

FIG. 2 illustrates a block diagram of a LIDAR system 200, according to an embodiment. System 200 includes a LIDAR transmitter 202 to generate and transmit a LIDAR beam and a LIDAR receiver 204 to receive/detect reflection of the LIDAR beam. In an embodiment, the beams is in the form of a pulsed laser to measure the distance between an object and the LiDAR receiver 204 based on detection of the reflection of the beam.

LIDAR transmitter 202 includes encode logic 206 (e.g., to cause encoding of the LIDAR beam), one or more light sources 208 (e.g., to generate a laser beam), optionally lens(es) 210 (e.g., to adjust the light beam generated by the laser source(s) 208), modulator 212 (e.g., to modulate the generated light beam), and optionally lens(es) 214 (e.g., to adjust the light beam prior to transmission of the beam towards an object. Encode logic 206 utilizes frequency hopping, pulse width variation, wavelength changing, amplitude adjustment, phase shifting, or any combinations thereof to encode the light beam, e.g., to enhance safety and/or avoid (or at least partially reduce a chance) for signal interference. The light source(s) 208 may include various types of laser light sources such as a pulsed diode laser source, uncooled fiber laser source, solid-state laser, liquid-crystal laser, dye laser, gas laser, etc. In some embodiments, one or more optical filters (not shown) may also be provided (in proximity to (or even embedded with) the optional lenses 210 and/or 214), e.g., to filter light beams in accordance with environmental characteristics (such as filter(s) to ensure correct operation in bright/sunny environments and/or to enable light beams to travel further).

Encode logic 206 may cause the light sources 208 to generate a beam with differing characteristics (e.g., frequency, amplitude, pulse width, wavelength, phase or combinations thereof) which may enhance encoding of LIDAR signals. Modulator 212 may modulate the light beam generated by the source(s) to modulate the beam's phase, frequency, amplitude, polarization, or any combinations thereof. In an embodiment, modulator 212 modulates the light beam based at least on input from the encode logic 206. Furthermore, modulator 212 may be an electro-optic modulator (e.g., including a lithium niobate crystal electro-optic modulator, liquid crystal electro-optic modulator, and the like) in some embodiments.

LIDAR receiver 204 includes optional lens(es) 216 (e.g., to adjust the light reflection received from an object), detector logic 218 (e.g., to detect the LIDR beam reflection), demodulator 222 (e.g., to demodulate the generated light beam reflection), and decode logic 220 (e.g., to cause decoding of the detected reflection beam and to determine whether the detected reflection beam match or otherwise corresponds to the encoded LIDAR beam based on encoding information). Decode logic 220 may communicate with detector 218 and/or demodulator 222 to determine whether the reflected beam is encoded and if so whether the encoded reflection beam matches or otherwise corresponds to the transmitted encoded LIDAR beam.

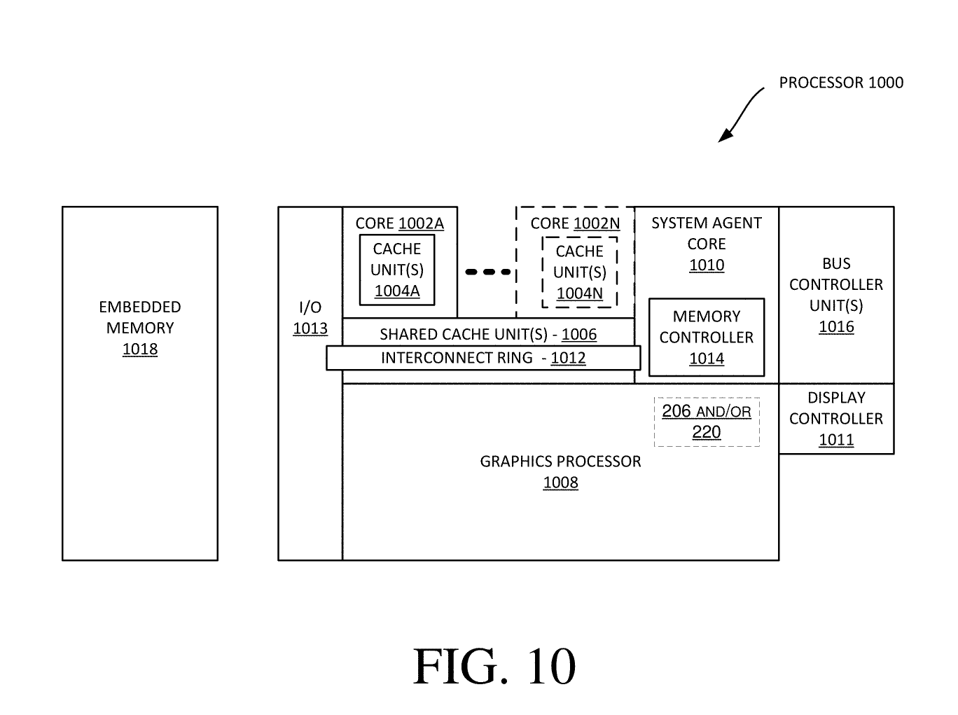

As shown in FIG. 2, encode logic 206 may transmit encoding information (e.g., information regarding changes to amplitude, frequency, pulse width, wavelength, phase, or combinations thereof) to the decode logic 220 to allow for detection of encoded reflection beams as well as determining whether a reflected beam corresponds to a transmitted beam per the encoding utilized. While encode logic 206 and decode logic 220 are shown as separate logic in FIG. 2, one or more embodiments combine these logics into the same logic. In an embodiment, encode logic 206 and/or decode logic 220 include one or more processors such as those discussed herein with reference to FIGS. 8-11. Also, encode logic 206 and/or decode logic 220 may utilize machine learning/deep learning to contract neural networks for faster encoding/decoding operations as well as detect more complicated encoding/decoding scenarios.

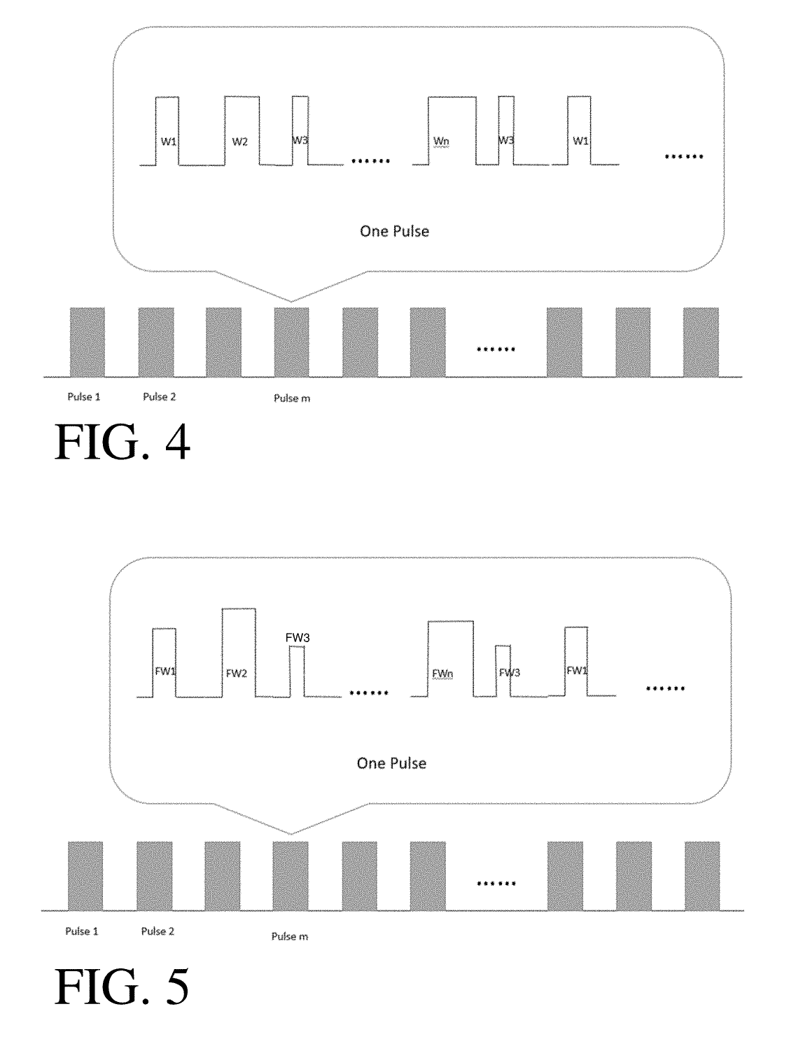

FIG. 3 illustrates encoding LIDAR signals with frequency hopping, according to an embodiment. As shown, the LIDAR beam includes a plurality of pulses (pulse 1 to pulse m). Each pulse may include a plurality of shorter sub-pulses with varying frequency (F1 to Fn). Moreover, in the embodiment of FIG. 3 encoding is done via varying the frequency of the LIDAR laser beam. The LIDAR system may continuously emit laser pulses and receive pulses reflected by any objects within the line of sight of the LIDAR system to detect the range to such objects. The change in frequency of the shorter pulses may be done dynamically, and the receiver only accepts reflected signal with same frequency pattern as valid. The frequency change pattern can be chosen from a list of pre-defined patterns, or user(s)/drive(s) may define a pattern based on preferences.

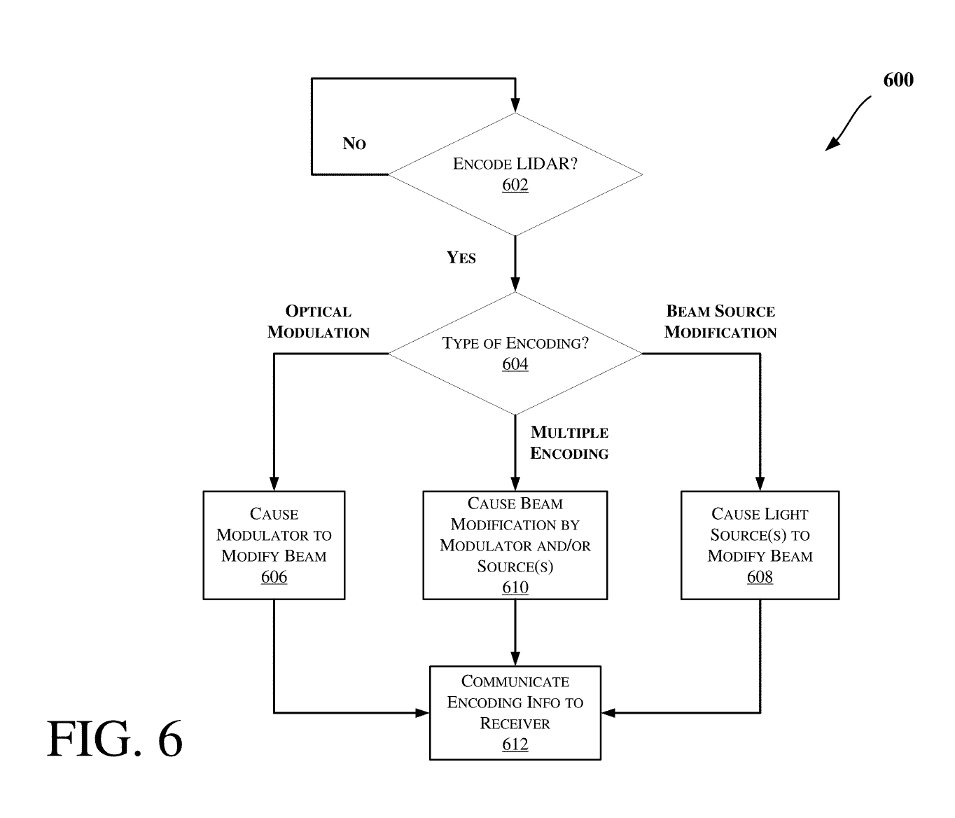

FIG. 4 illustrates encoding LIDAR signals with pulse width encoding, according to an embodiment. As shown, the LIDAR beam includes a plurality of pulses (pulse 1 to pulse m). Each pulse may include a plurality of shorter sub-pulses with varying width (W1 to Wn). While some figures may use the same index label (e.g., “n” or “m”) to refer to some components, these index labels are not meant to be limiting and do not always refer to the same value. The LIDAR system may continuously emit laser pulses and receive pulses reflected by any objects within the line of sight of the LIDAR system to detect the range to such objects. The change in width of the shorter pulses may be done dynamically, and the receiver only accepts reflected signal with same width pattern as valid. The wavelength or pulse width change pattern can be chosen from a list of pre-defined patterns, or user(s)/driver(s) may define a pattern based on preferences.

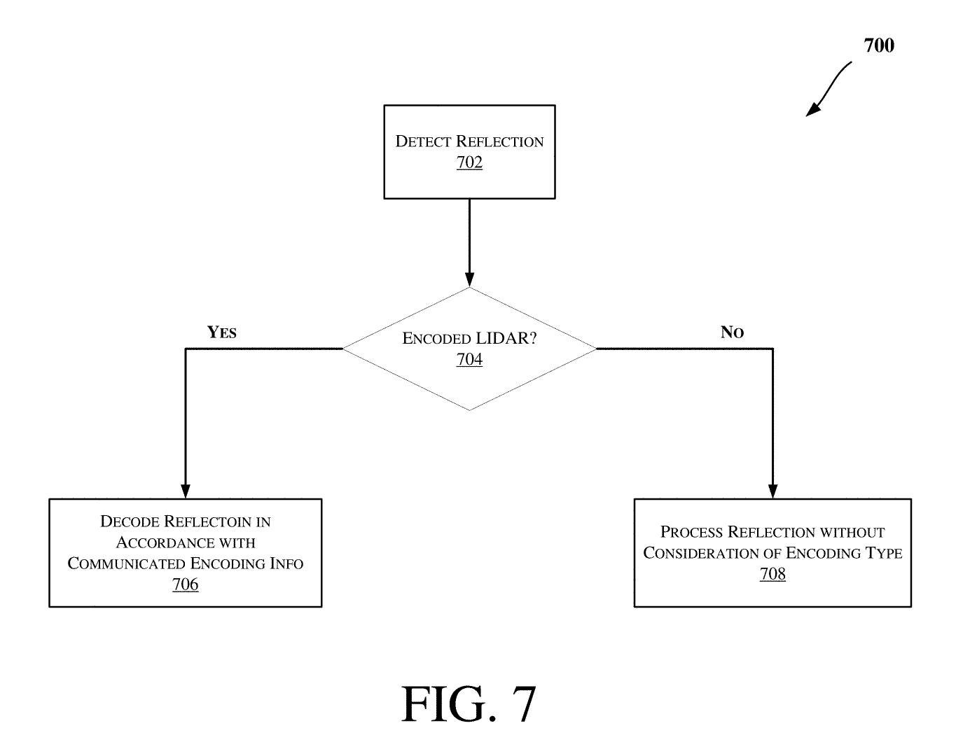

FIG. 5 illustrates encoding LIDAR signals with frequency and pulse width encoding, according to an embodiment. As shown, the LIDAR beam includes a plurality of pulses (pulse 1 to pulse m). Each pulse may include a plurality of shorter sub-pulses with varying frequency and width (FW1 to FWn). The LIDAR system may continuously emit laser pulses and receive pulses reflected by any objects within the line of sight of the LIDAR system to detect the range to such objects. The change in frequency and width of the shorter pulses may be done dynamically, and the receiver only accepts reflected signal with same frequency-width pattern as valid. The pulse frequency-width change pattern can be chosen from a list of pre-defined patterns, or user(s)/driver(s) may define a pattern based on preferences.

As previously mentioned, the encoding may also be performed based on phase or amplitude changes, such as discussed with reference to frequency and width changes discussed with reference to FIGS. 3-5. Also, any combination of phase, amplitude, frequency, or width changes may be used in some embodiments, including changing more than one these factors for the series of shorter pulses. For example, a first shorter pulse may use frequency F1 and width W3, while a second shorter pulse in the same pulse may use frequency F4 and W5, and so on. Further, each of the light sources 208 of FIG. 2 may emit a beam with a different frequency, wavelength, amplitude, and/or phase in some embodiments.

In one embodiment, the encoding/decoding devices discussed herein may be coupled to or included with an IoT device. Moreover, an “IoT” device generally refers to a device which includes electronic processing circuitry (such as one or more processor/cores, PLA (Programmable Logic Array), Field Programmable Gate Array (FPGA), SoC, ASIC (Application Specific Integrated Circuit), etc.), memory (e.g., to store software or firmware), one or more sensors (or is otherwise coupled to one or more sensors such as a camera, motion detector, etc.), and network connectivity to allow the IoT device to collect and/or exchange data. IoT devices can be cheaper than traditional computing devices to allow for their proliferation at remote locations. IoT devices can also reduce costs by using existing infrastructure (such as the Internet, a (third generation (3G), fourth generation (4G), or fifth generation (5G) cellular/wireless network, etc.). More generally, an IoT device may include one or more components such as those discussed with reference to FIG. 1 et seq.

Moreover, information discussed herein (such as the encoding information, pattern/user preference(s), etc.) may be stored in any type of memory (including volatile or non-volatile memory) discussed herein. Also, such information may be stored in one or more locations such as in a vehicle(s), cloud, etc.

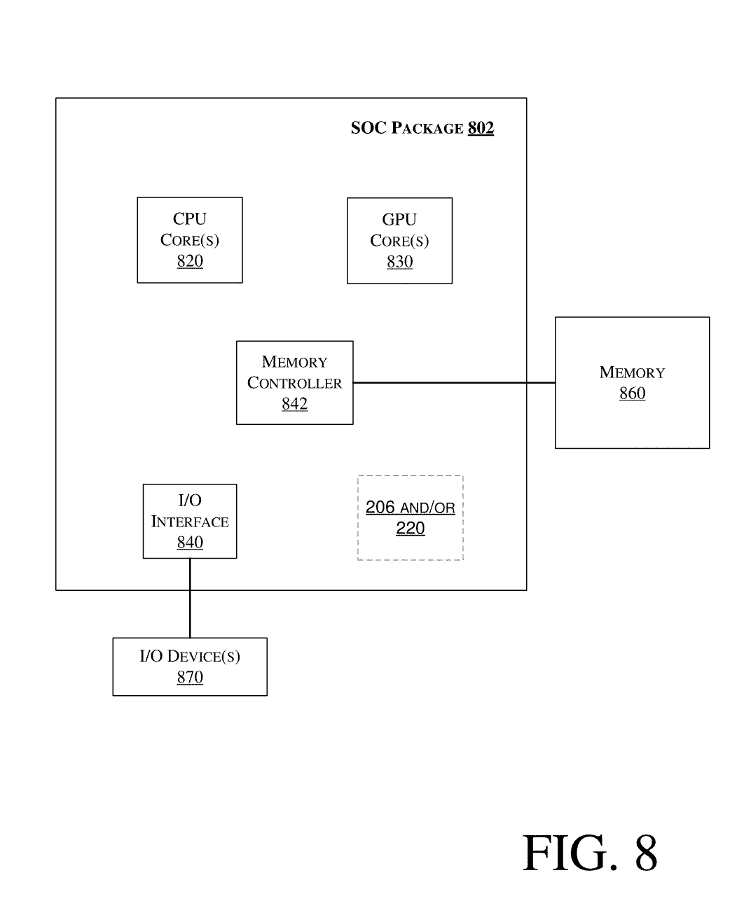

FIG. 6 illustrates a flow diagram of a method 600 for encoding LIDAR signals, according to an embodiment. One or more operations of method 600 may be performed by logic (e.g., logic 206) and/or one or more components discussed herein with reference to FIGS. 1 to 13 (such as a processor, a GPU, etc.).

Referring to FIGS. 1-6, operation 602 determines whether LIDAR pulses should be encoded (e.g., based on user/driver/owner input). Operation 604 determines which type or types of encoding to apply (e.g., selected from the afore mentioned options of frequency, amplitude, width, phase, or combinations thereof). Depending on the selected type of encoding t operation 604, operations 606-608 cause the light source(s) 208 and/or modulator 210 to modify the beam. Operation 612 communicates the encoding information to the LIDAR receiver 204.

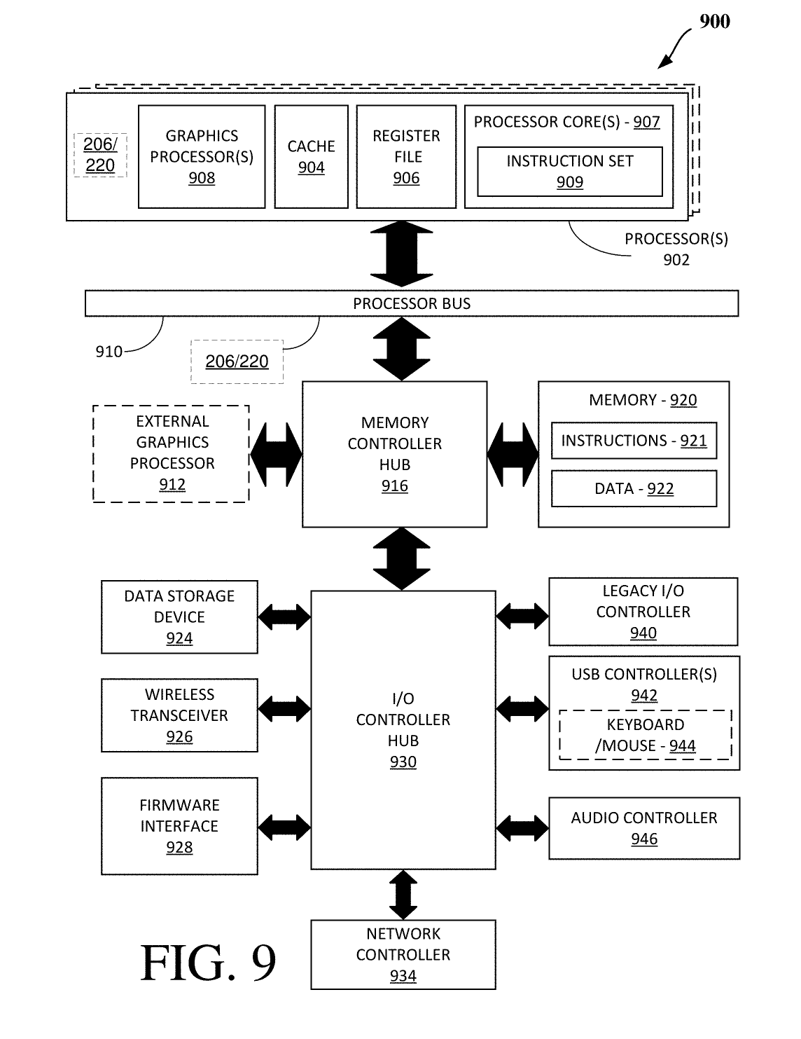

FIG. 7 illustrates a flow diagram of a method 700 for decoding reflected LIDAR signals, according to an embodiment. One or more operations of method 700 may be performed by logic (e.g., logic 218-222) and/or one or more components discussed herein with reference to FIGS. 1 to 13 (such as a processor, a GPU, etc.).

Referring to FIGS. 1-7, operation 702 detects (e.g., by logic 218) LIDAR pulses reflected by an object. Operation 704 determines whether the detected pulses are encoded (e.g., by logic 218 and/or 220). Depending on the determination at operation 704, operations 706 and 708 decode the reflected pulses in accordance with communicated encoding information or just process the reflections without consideration for encoding types.

Furthermore, some embodiments may be applied in computing devices that include one or more processors (e.g., with one or more processor cores), such as those discussed with reference to FIGS. 1 to 13, including for example small form factor or mobile computing devices, e.g., an IoT device, M2M device, a smartphone, tablet, UMPC (Ultra-Mobile Personal Computer), laptop computer, Ultrabook™ computing device, wearable devices (such as a smart watch, smart glasses, etc.), 2 in 1 systems, etc. Also, some embodiments are applied in computing devices that include a cooling fan as well as fanless computing devices.

FIG. 8 illustrates a block diagram of an SOC package in accordance with an embodiment. As illustrated in FIG. 8, SOC 802 includes one or more Central Processing Unit (CPU) cores 820, one or more Graphics Processor Unit (GPU) cores 830, an Input/Output (I/O) interface 840, and a memory controller 842. Various components of the SOC package 802 may be coupled to an interconnect or bus such as discussed herein with reference to the other figures. Also, the SOC package 802 may include more or less components, such as those discussed herein with reference to the other figures. Further, each component of the SOC package 820 may include one or more other components, e.g., as discussed with reference to the other figures herein. In one embodiment, SOC package 802 (and its components) is provided on one or more Integrated Circuit (IC) die, e.g., which are packaged into a single semiconductor device.

As illustrated in FIG. 8, SOC package 802 is coupled to a memory 860 via the memory controller 842. In an embodiment, the memory 860 (or a portion of it) can be integrated on the SOC package 802.

The I/O interface 840 may be coupled to one or more I/O devices 870, e.g., via an interconnect and/or bus such as discussed herein with reference to other figures. I/O device(s) 870 may include one or more of a keyboard, a mouse, a touchpad, a display, an image/video capture device (such as a camera or camcorder/video recorder), a touch screen, a speaker, or the like.

FIG. 9 is a block diagram of a processing system 900, according to an embodiment. In various embodiments the system 900 includes one or more processors 902 and one or more graphics processors 908, and may be a single processor desktop system, a multiprocessor workstation system, or a server system having a large number of processors 902 or processor cores 907. In on embodiment, the system 900 is a processing platform incorporated within a system-on-a-chip (SoC or SOC) integrated circuit for use in mobile, handheld, or embedded devices.

An embodiment of system 900 can include, or be incorporated within a server-based gaming platform, a game console, including a game and media console, a mobile gaming console, a handheld game console, or an online game console. In some embodiments system 900 is a mobile phone, smart phone, tablet computing device or mobile Internet device. Data processing system 900 can also include, couple with, or be integrated within a wearable device, such as a smart watch wearable device, smart eyewear device, augmented reality device, or virtual reality device. In some embodiments, data processing system 900 is a television or set top box device having one or more processors 902 and a graphical interface generated by one or more graphics processors 908.

In some embodiments, the one or more processors 902 each include one or more processor cores 907 to process instructions which, when executed, perform operations for system and user software. In some embodiments, each of the one or more processor cores 907 is configured to process a specific instruction set 909. In some embodiments, instruction set 909 may facilitate Complex Instruction Set Computing (CISC), Reduced Instruction Set Computing (RISC), or computing via a Very Long Instruction Word (VLIW). Multiple processor cores 907 may each process a different instruction set 909, which may include instructions to facilitate the emulation of other instruction sets. Processor core 907 may also include other processing devices, such a Digital Signal Processor (DSP).

In some embodiments, the processor 902 includes cache memory 904. Depending on the architecture, the processor 902 can have a single internal cache or multiple levels of internal cache. In some embodiments, the cache memory is shared among various components of the processor 902. In some embodiments, the processor 902 also uses an external cache (e.g., a Level-3 (L3) cache or Last Level Cache (LLC)) (not shown), which may be shared among processor cores 907 using known cache coherency techniques. A register file 906 is additionally included in processor 902 which may include different types of registers for storing different types of data (e.g., integer registers, floating point registers, status registers, and an instruction pointer register). Some registers may be general-purpose registers, while other registers may be specific to the design of the processor 902.

In some embodiments, processor 902 is coupled to a processor bus 910 to transmit communication signals such as address, data, or control signals between processor 902 and other components in system 900. In one embodiment the system 900 uses an exemplary ‘hub’ system architecture, including a memory controller hub 916 and an Input Output (I/O) controller hub 930. A memory controller hub 916 facilitates communication between a memory device and other components of system 900, while an I/O Controller Hub (ICH) 930 provides connections to I/O devices via a local I/O bus. In one embodiment, the logic of the memory controller hub 916 is integrated within the processor.

Memory device 920 can be a dynamic random access memory (DRAM) device, a static random access memory (SRAM) device, flash memory device, phase-change memory device, or some other memory device having suitable performance to serve as process memory. In one embodiment the memory device 920 can operate as system memory for the system 900, to store data 922 and instructions 921 for use when the one or more processors 902 executes an application or process. Memory controller hub 916 also couples with an optional external graphics processor 912, which may communicate with the one or more graphics processors 908 in processors 902 to perform graphics and media operations.

In some embodiments, ICH 930 enables peripherals to connect to memory device 920 and processor 902 via a high-speed I/O bus. The I/O peripherals include, but are not limited to, an audio controller 946, a firmware interface 928, a wireless transceiver 926 (e.g., Wi-Fi, Bluetooth), a data storage device 924 (e.g., hard disk drive, flash memory, etc.), and a legacy I/O controller 940 for coupling legacy (e.g., Personal System 2 (PS/2)) devices to the system. One or more Universal Serial Bus (USB) controllers 942 connect input devices, such as keyboard and mouse 944 combinations. A network controller 934 may also couple to ICH 930. In some embodiments, a high-performance network controller (not shown) couples to processor bus 910. It will be appreciated that the system 900 shown is exemplary and not limiting, as other types of data processing systems that are differently configured may also be used. For example, the I/O controller hub 930 may be integrated within the one or more processor 902, or the memory controller hub 916 and I/O controller hub 930 may be integrated into a discreet external graphics processor, such as the external graphics processor 912.

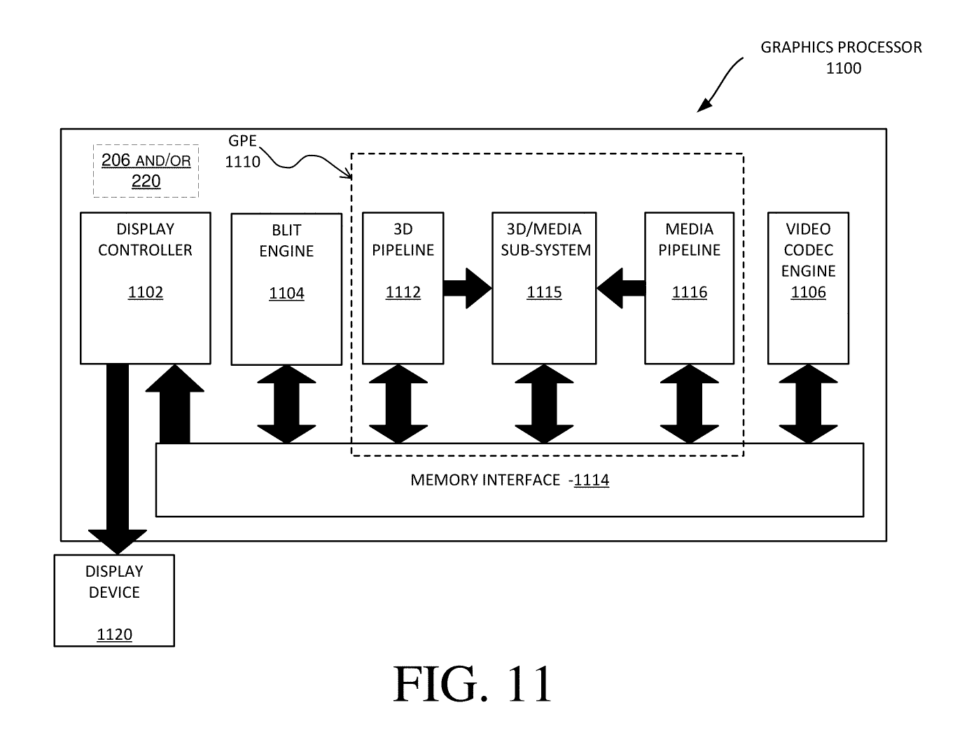

FIG. 10 is a block diagram of an embodiment of a processor 1000 having one or more processor cores 1002A to 1002N, an integrated memory controller 1014, and an integrated graphics processor 1008. Those elements of FIG. 10 having the same reference numbers (or names) as the elements of any other figure herein can operate or function in any manner similar to that described elsewhere herein, but are not limited to such. Processor 1000 can include additional cores up to and including additional core 1002N represented by the dashed lined boxes. Each of processor cores 1002A to 1002N includes one or more internal cache units 1004A to 1004N. In some embodiments each processor core also has access to one or more shared cached units 1006.

The internal cache units 1004A to 1004N and shared cache units 1006 represent a cache memory hierarchy within the processor 1000. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 1006 and 1004A to 1004N.

In some embodiments, processor 1000 may also include a set of one or more bus controller units 1016 and a system agent core 1010. The one or more bus controller units 1016 manage a set of peripheral buses, such as one or more Peripheral Component Interconnect buses (e.g., PCI, PCI Express). System agent core 1010 provides management functionality for the various processor components. In some embodiments, system agent core 1010 includes one or more integrated memory controllers 1014 to manage access to various external memory devices (not shown).

In some embodiments, one or more of the processor cores 1002A to 1002N include support for simultaneous multi-threading. In such embodiment, the system agent core 1010 includes components for coordinating and operating cores 1002A to 1002N during multi-threaded processing. System agent core 1010 may additionally include a power control unit (PCU), which includes logic and components to regulate the power state of processor cores 1002A to 1002N and graphics processor 1008.

In some embodiments, processor 1000 additionally includes graphics processor 1008 to execute graphics processing operations. In some embodiments, the graphics processor 1008 couples with the set of shared cache units 1006, and the system agent core 1010, including the one or more integrated memory controllers 1014. In some embodiments, a display controller 1011 is coupled with the graphics processor 1008 to drive graphics processor output to one or more coupled displays. In some embodiments, display controller 1011 may be a separate module coupled with the graphics processor via at least one interconnect, or may be integrated within the graphics processor 1008 or system agent core 1010.

In some embodiments, a ring based interconnect unit 1012 is used to couple the internal components of the processor 1000. However, an alternative interconnect unit may be used, such as a point-to-point interconnect, a switched interconnect, or other techniques, including techniques well known in the art. In some embodiments, graphics processor 1008 couples with the ring interconnect 1012 via an I/O link 1013.

The exemplary I/O link 1013 represents at least one of multiple varieties of I/O interconnects, including an on package I/O interconnect which facilitates communication between various processor components and a high-performance embedded memory module 1018, such as an eDRAM (or embedded DRAM) module. In some embodiments, each of the processor cores 1002 to 1002N and graphics processor 1008 use embedded memory modules 1018 as a shared Last Level Cache.

In some embodiments, processor cores 1002A to 1002N are homogenous cores executing the same instruction set architecture. In another embodiment, processor cores 1002A to 1002N are heterogeneous in terms of instruction set architecture (ISA), where one or more of processor cores 1002A to 1002N execute a first instruction set, while at least one of the other cores executes a subset of the first instruction set or a different instruction set. In one embodiment processor cores 1002A to 1002N are heterogeneous in terms of microarchitecture, where one or more cores having a relatively higher power consumption couple with one or more power cores having a lower power consumption. Additionally, processor 1000 can be implemented on one or more chips or as an SoC integrated circuit having the illustrated components, in addition to other components.

FIG. 11 is a block diagram of a graphics processor 1100, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 1100 includes a memory interface 1114 to access memory. Memory interface 1114 can be an interface to local memory, one or more internal caches, one or more shared external caches, and/or to system memory.

In some embodiments, graphics processor 1100 also includes a display controller 1102 to drive display output data to a display device 1120. Display controller 1102 includes hardware for one or more overlay planes for the display and composition of multiple layers of video or user interface elements. In some embodiments, graphics processor 1100 includes a video codec engine 1106 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 1100 includes a block image transfer (BLIT) engine 1104 to perform two-dimensional (2D) rasterizer operations including, for example, bit-boundary block transfers. However, in one embodiment, 11D graphics operations are performed using one or more components of graphics processing engine (GPE) 1110. In some embodiments, graphics processing engine 1110 is a compute engine for performing graphics operations, including three-dimensional (3D) graphics operations and media operations.

In some embodiments, GPE 1110 includes a 3D pipeline 1112 for performing 3D operations, such as rendering three-dimensional images and scenes using processing functions that act upon 3D primitive shapes (e.g., rectangle, triangle, etc.). The 3D pipeline 1112 includes programmable and fixed function elements that perform various tasks within the element and/or spawn execution threads to a 3D/Media sub-system 1115. While 3D pipeline 1112 can be used to perform media operations, an embodiment of GPE 1110 also includes a media pipeline 1116 that is specifically used to perform media operations, such as video post-processing and image enhancement.

In some embodiments, media pipeline 1116 includes fixed function or programmable logic units to perform one or more specialized media operations, such as video decode acceleration, video de-interlacing, and video encode acceleration in place of, or on behalf of video codec engine 1106. In some embodiments, media pipeline 1116 additionally includes a thread spawning unit to spawn threads for execution on 3D/Media sub-system 1115. The spawned threads perform computations for the media operations on one or more graphics execution units included in 3D/Media sub-system 1115.

In some embodiments, 3D/Media subsystem 1115 includes logic for executing threads spawned by 3D pipeline 1112 and media pipeline 1116. In one embodiment, the pipelines send thread execution requests to 3D/Media subsystem 1115, which includes thread dispatch logic for arbitrating and dispatching the various requests to available thread execution resources. The execution resources include an array of graphics execution units to process the 3D and media threads. In some embodiments, 3D/Media subsystem 1115 includes one or more internal caches for thread instructions and data. In some embodiments, the subsystem also includes shared memory, including registers and addressable memory, to share data between threads and to store output data.

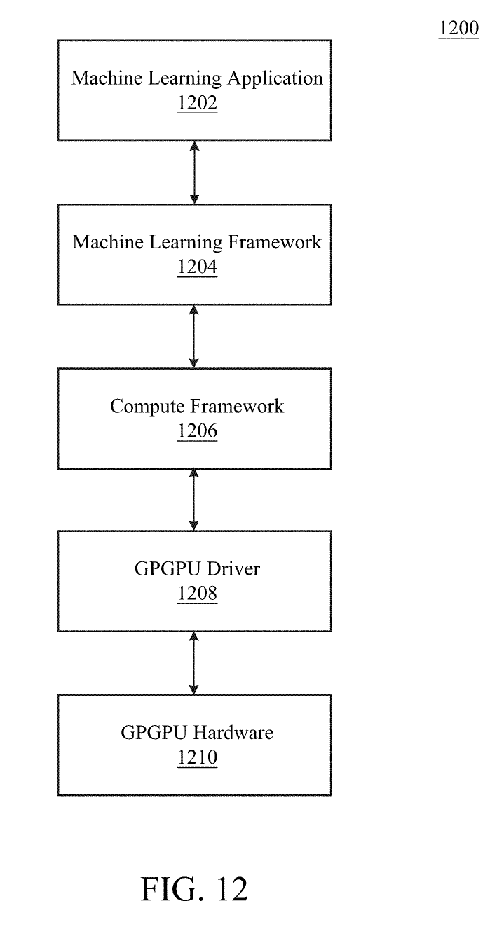

FIG. 12 is a generalized diagram of a machine learning software stack 1200. A machine learning application 1202 can be configured to train a neural network or other similar supervised machine learning techniques using a training dataset or to use a trained deep neural network to implement machine intelligence. Moreover, while one or more embodiments are discussed herein with reference to heavy deep learning implementations, embodiments are not limited to such implementations and any supervised machine learning algorithm can be used, such as Bayesian Network (also referred to as Bayes Net), Random Forest, Logistic Regression, SVM (Support Vector Machine), Neural Network, Deep Neural Network, or any combinations thereof. The machine learning application 1202 can include training and inference functionality for a neural network and/or specialized software that can be used to train a neural network before deployment. The machine learning application 1202 can implement any type of machine intelligence including but not limited to image recognition, mapping and localization, autonomous navigation, speech synthesis, medical imaging, or language translation.

Hardware acceleration for the machine learning application 1202 can be enabled via a machine learning framework 1204. The machine learning framework 1204 can provide a library of machine learning primitives. Machine learning primitives are basic operations that are commonly performed by machine learning algorithms. Without the machine learning framework 1204, developers of machine learning algorithms would be required to create and optimize the main computational logic associated with the machine learning algorithm, then re-optimize the computational logic as new parallel processors are developed. Instead, the machine learning application can be configured to perform the necessary computations using the primitives provided by the machine learning framework 1204. Exemplary primitives include tensor convolutions, activation functions, and pooling, which are computational operations that are performed while training a convolutional neural network (CNN). The machine learning framework 1204 can also provide primitives to implement basic linear algebra subprograms performed by many machine-learning algorithms, such as matrix and vector operations.

The machine learning framework 1204 can process input data received from the machine learning application 1202 and generate the appropriate input to a compute framework 1206. The compute framework 1206 can abstract the underlying instructions provided to the GPGPU driver 1208 to enable the machine learning framework 1204 to take advantage of hardware acceleration via the GPGPU hardware 1210 without requiring the machine learning framework 1204 to have intimate knowledge of the architecture of the GPGPU hardware 1210. Additionally, the compute framework 1206 can enable hardware acceleration for the machine learning framework 1204 across a variety of types and generations of the GPGPU hardware 1210.

The computing architecture provided by embodiments described herein can be configured to perform the types of parallel processing that is particularly suited for training and deploying neural networks for machine learning. A neural network can be generalized as a network of functions having a graph relationship. As is known in the art, there are a variety of types of neural network implementations used in machine learning. One exemplary type of neural network is the feedforward network, as previously described.

A second exemplary type of neural network is the Convolutional Neural Network (CNN). A CNN is a specialized feedforward neural network for processing data having a known, grid-like topology, such as image data. Accordingly, CNNs are commonly used for compute vision and image recognition applications, but they also may be used for other types of pattern recognition such as speech and language processing. The nodes in the CNN input layer are organized into a set of “filters” (feature detectors inspired by the receptive fields found in the retina), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful for language processing due to the variable nature in which language data can be composed.

The figures described herein present exemplary feedforward, CNN, and RNN networks, as well as describe a general process for respectively training and deploying each of those types of networks. It will be understood that these descriptions are exemplary and non-limiting as to any specific embodiment described herein and the concepts illustrated can be applied generally to deep neural networks and machine learning techniques in general.

The exemplary neural networks described above can be used to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different task.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

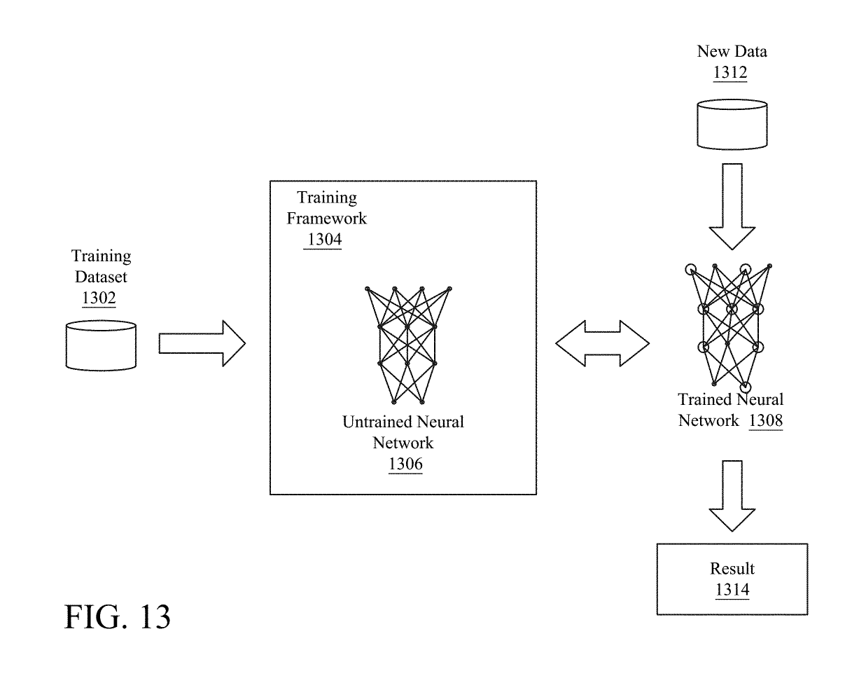

FIG. 13 illustrates training and deployment of a deep neural network. Once a given network has been structured for a task the neural network is trained using a training dataset 1302. Various training frameworks have been developed to enable hardware acceleration of the training process. For example, the machine learning framework 1204 of FIG. 12 may be configured as a training framework 1304. The training framework 1304 can hook into an untrained neural network 1306 and enable the untrained neural net to be trained using the parallel processing resources described herein to generate a trained neural network 1308. To start the training process the initial weights may be chosen randomly or by pre-training using a deep belief network. The training cycle then be performed in either a supervised or unsupervised manner.

Supervised learning is a learning method in which training is performed as a mediated operation, such as when the training dataset 1302 includes input paired with the desired output for the input, or where the training dataset includes input having known output and the output of the neural network is manually graded. The network processes the inputs and compares the resulting outputs against a set of expected or desired outputs. Errors are then propagated back through the system. The training framework 1304 can adjust to adjust the weights that control the untrained neural network 1306. The training framework 1304 can provide tools to monitor how well the untrained neural network 1306 is converging towards a model suitable to generating correct answers based on known input data. The training process occurs repeatedly as the weights of the network are adjusted to refine the output generated by the neural network. The training process can continue until the neural network reaches a statistically desired accuracy associated with a trained neural network 1308. The trained neural network 1308 can then be deployed to implement any number of machine learning operations.

Unsupervised learning is a learning method in which the network attempts to train itself using unlabeled data. Thus, for unsupervised learning the training dataset 1302 will include input data without any associated output data. The untrained neural network 1306 can learn groupings within the unlabeled input and can determine how individual inputs are related to the overall dataset. Unsupervised training can be used to generate a self-organizing map, which is a type of trained neural network 1307 capable of performing operations useful in reducing the dimensionality of data. Unsupervised training can also be used to perform anomaly detection, which allows the identification of data points in an input dataset that deviate from the normal patterns of the data.

Variations on supervised and unsupervised training may also be employed. Semi-supervised learning is a technique in which in the training dataset 1302 includes a mix of labeled and unlabeled data of the same distribution. Incremental learning is a variant of supervised learning in which input data is continuously used to further train the model. Incremental learning enables the trained neural network 1308 to adapt to the new data 1312 without forgetting the knowledge instilled within the network during initial training.

Whether supervised or unsupervised, the training process for particularly deep neural networks may be too computationally intensive for a single compute node. Instead of using a single compute node, a distributed network of computational nodes can be used to accelerate the training process.

The following examples pertain to further embodiments. Example 1 includes an apparatus comprising: encode logic to encode a plurality of light beam pulses prior to transmission of the plurality of light beam pulses from at least one light source towards an object; and memory, coupled to the encode logic, to store encoding information indicative of a type of encoding to be applied to the plurality of light beam pulses, wherein each of the plurality of light beam pulses comprises one or more sub-pulses, wherein the encode logic is to cause a modification to at least one of the one or more sub-pulses to encode the plurality of light beam pulses. Example 2 includes the apparatus of example 1, wherein the plurality of light beam pulses comprise Light Detection And Ranging (LIDAR) pulses. Example 3 includes the apparatus of example 1, wherein the modification comprises a change to one or more of: frequency, width, phase, or amplitude of the at least one of the one or more sub-pulses. Example 4 includes the apparatus of example 1, wherein the encode logic is to cause the modification via a modulator or the at least one light source. Example 5 includes the apparatus of example 4, wherein the modulator comprises an electro-optic modulator. Example 6 includes the apparatus of example 5, wherein the electro-optic modulator comprises a lithium niobate crystal electro-optic modulator or a liquid crystal electro-optic modulator. Example 7 includes the apparatus of example 1, wherein the at least one light source comprises: a pulsed diode laser source, an uncooled fiber laser source, solid-state laser source, liquid-crystal laser source, dye laser source, or gas laser source. Example 8 includes the apparatus of example 1, further comprising a plurality of light sources, wherein each of the plurality of light sources is to emit a different type of light beam. Example 9 includes the apparatus of example 8, wherein the different type of light beam comprises a light beam with a different frequency, phase, amplitude, wavelength, or combinations thereof. Example 10 includes the apparatus of example 1, wherein the at least one light source is to generate a laser beam. Example 11 includes the apparatus of example 1, wherein decode logic is to access the stored encoding information to facilitate decoding of reflections of the plurality of light beam pulses. Example 12 includes the apparatus of example 1, wherein the encode logic is to encode the plurality of light beam pulses based at least in part on machine learning or deep learning. Example 13 includes the apparatus of example 1, wherein an Internet of Things (IoT) device or vehicle comprises the encode logic or the memory. Example 14 includes the apparatus of example 1, wherein a processor, having one or more processor cores, comprises the encode logic. Example 15 includes the apparatus of example 1, wherein a single integrated device comprises one or more of: a processor, the encode logic, and the memory.

Example 16 includes an apparatus comprising: decode logic to decode a plurality of light beam pulses based on encoding information indicative of a type of encoding applied to the plurality of light beam pulses, wherein each of the plurality of light beam pulses comprises one or more sub-pulses, wherein the decode logic is to detect a modification to at least one of the one or more sub-pulses to decode the plurality of light beam pulses. Example 17 includes the apparatus of example 16, comprising logic to indicate whether the at least one of the one or more sub-pulses is authentic in response to comparison of the modification with the encoding information. Example 18 includes the apparatus of example 16, wherein the modification comprises a change to one or more of: frequency, width, phase, or amplitude of the at least one of the one or more sub-pulses. Example 19 includes the apparatus of example 16, wherein the plurality of light beam pulses comprise Light Detection And Ranging (LIDAR) pulses. Example 20 includes the apparatus of example 16, further comprising memory to store the encoding information. Example 21 includes the apparatus of example 16, wherein encoding logic is to provide the encoding information. Example 22 includes the apparatus of example 16, wherein the decode logic is to detect the modification based on an indication from a demodulator or a detector.

Example 23 includes a computing system comprising: a processor having one or more processor cores; memory, coupled to the processor, to store one or more bits of data corresponding to encoding information; and logic to process a plurality of light beam pulses prior to transmission of the plurality of light beam pulses from at least one light source towards an object or to process a plurality of light beam pulses based on the encoding information, wherein the encoding information is indicative of a type of encoding applied to the plurality of light beam pulses, wherein each of the plurality of light beam pulses comprises one or more sub-pulses, wherein the plurality of light beam pulses comprise Light Detection And Ranging (LIDAR) pulses. Example 24 includes the computing system of example 23, wherein the logic is to cause a modification to at least one of the one or more sub-pulses to encode the plurality of light beam pulses. Example 25 includes the computing system of example 23, wherein the logic is to detect a modification to at least one of the one or more sub-pulses to decode the plurality of light beam pulses. Example 26 includes the computing system of example 24, wherein the modification comprises a change to one or more of: frequency, width, phase, or amplitude of the at least one of the one or more sub-pulses. Example 27 includes the computing system of example 24, wherein the logic is to cause the modification via a modulator or the at least one light source. Example 28 includes the computing system of example 23, wherein the at least one light source comprises: a pulsed diode laser source, an uncooled fiber laser source, solid-state laser source, liquid-crystal laser source, dye laser source, or gas laser source. Example 29 includes the computing system of example 23, further comprising a plurality of light sources, wherein each of the plurality of light sources is to emit a different type of light beam. Example 30 includes the computing system of example 23, wherein the at least one light source is to generate a laser beam. Example 31 includes the computing system of example 25, wherein the logic is to access the stored encoding information to facilitate decoding of reflections of the plurality of light beam pulses. Example 32 includes the computing system of example 23, wherein the processor comprises the logic. Example 33 includes the computing system of example 23, wherein a single integrated device comprises one or more of: the processor, the logic, and the memory.

Example 34 includes a method comprising: processing a plurality of light beam pulses prior to transmission of the plurality of light beam pulses from at least one light source towards an object or processing a plurality of light beam pulses based on the encoding information, wherein the encoding information is indicative of a type of encoding applied to the plurality of light beam pulses, wherein each of the plurality of light beam pulses comprises one or more sub-pulses, wherein the plurality of light beam pulses comprise Light Detection And Ranging (LIDAR) pulses. Example 35 includes the method of example 34, further comprising causing a modification to at least one of the one or more sub-pulses to encode the plurality of light beam pulses. Example 36 includes the method of example 34, further comprising detecting a modification to at least one of the one or more sub-pulses to decode the plurality of light beam pulses.

Example 37 includes one or more computer-readable medium comprising one or more instructions that when executed on at least one processor configure the at least one processor to perform one or more operations to: process a plurality of light beam pulses prior to transmission of the plurality of light beam pulses from at least one light source towards an object or process a plurality of light beam pulses based on the encoding information, wherein the encoding information is indicative of a type of encoding applied to the plurality of light beam pulses, wherein each of the plurality of light beam pulses comprises one or more sub-pulses, wherein the plurality of light beam pulses comprise Light Detection And Ranging (LIDAR) pulses. Example 38 includes the computer-readable medium of example 37, further comprising one or more instructions that when executed on the at least one processor configure the at least one processor to perform one or more operations to cause a modification to at least one of the one or more sub-pulses to encode the plurality of light beam pulses. Example 39 includes the computer-readable medium of example 37, further comprising one or more instructions that when executed on the at least one processor configure the at least one processor to perform one or more operations to cause detection of a modification to at least one of the one or more sub-pulses to decode the plurality of light beam pulses.

Example 40 includes an apparatus comprising means to perform a method as set forth in any preceding example. Example 41 comprises machine-readable storage including machine-readable instructions, when executed, to implement a method or realize an apparatus as set forth in any preceding example.

In various embodiments, the operations discussed herein, e.g., with reference to FIG. 1 et seq., may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIG. 1 et seq.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
encode logic to encode a plurality of light beam pulses prior to transmission of the plurality of light beam pulses from at least one light source towards an object; and
memory, coupled to the encode logic, to store encoding information indicative of a type of encoding to be applied to the plurality of light beam pulses,
wherein each of the plurality of light beam pulses comprises one or more sub-pulses, wherein the encode logic is to cause a modification to at least one of the one or more sub-pulses to encode the plurality of light beam pulses.

2. The apparatus of claim 1, wherein the plurality of light beam pulses comprise Light Detection And Ranging (LIDAR) pulses.

3. The apparatus of claim 1, wherein the modification comprises a change to one or more of: frequency, width, phase, or amplitude of the at least one of the one or more sub-pulses.

4. The apparatus of claim 1, wherein the encode logic is to cause the modification via a modulator or the at least one light source.

5. The apparatus of claim 4, wherein the modulator comprises an electro-optic modulator.

6. The apparatus of claim 5, wherein the electro-optic modulator comprises a lithium niobate crystal electro-optic modulator or a liquid crystal electro-optic modulator.

7. The apparatus of claim 1, wherein the at least one light source comprises: a pulsed diode laser source, an uncooled fiber laser source, solid-state laser source, liquid-crystal laser source, dye laser source, or gas laser source.

8. The apparatus of claim 1, further comprising a plurality of light sources, wherein each of the plurality of light sources is to emit a different type of light beam.

9. The apparatus of claim 8, wherein the different type of light beam comprises a light beam with a different frequency, phase, amplitude, wavelength, or combinations thereof.

10. The apparatus of claim 1, wherein the at least one light source is to generate a laser beam.

11. The apparatus of claim 1, wherein decode logic is to access the stored encoding information to facilitate decoding of reflections of the plurality of light beam pulses.

12. The apparatus of claim 1, wherein the encode logic is to encode the plurality of light beam pulses based at least in part on machine learning or deep learning.

13. The apparatus of claim 1, wherein an Internet of Things (IoT) device or vehicle comprises the encode logic or the memory.

14. The apparatus of claim 1, wherein a processor, having one or more processor cores, comprises the encode logic.

15. The apparatus of claim 1, wherein a single integrated device comprises one or more of: a processor, the encode logic, and the memory.

16. An apparatus comprising:
decode logic to decode a plurality of light beam pulses based on encoding information indicative of a type of encoding applied to the plurality of light beam pulses,
wherein each of the plurality of light beam pulses comprises one or more sub-pulses, wherein the decode logic is to detect a modification to at least one of the one or more sub-pulses to decode the plurality of light beam pulses.

17. The apparatus of claim 16, comprising logic to indicate whether the at least one of the one or more sub-pulses is authentic in response to comparison of the modification with the encoding information.

18. The apparatus of claim 16, wherein the modification comprises a change to one or more of: frequency, width, phase, or amplitude of the at least one of the one or more sub-pulses.

19. The apparatus of claim 16, wherein the plurality of light beam pulses comprise Light Detection And Ranging (LIDAR) pulses.

20. The apparatus of claim 16, further comprising memory to store the encoding information.

21. The apparatus of claim 16, wherein encoding logic is to provide the encoding information.

22. The apparatus of claim 16, wherein the decode logic is to detect the modification based on an indication from a demodulator or a detector.

23. A computing system comprising:
a processor having one or more processor cores;
memory, coupled to the processor, to store one or more bits of data corresponding to encoding information; and
logic to process a plurality of light beam pulses prior to transmission of the plurality of light beam pulses from at least one light source towards an object or to process a plurality of light beam pulses based on the encoding information,
wherein the encoding information is indicative of a type of encoding applied to the plurality of light beam pulses, wherein each of the plurality of light beam pulses comprises one or more sub-pulses, wherein the plurality of light beam pulses comprise Light Detection And Ranging (LIDAR) pulses.

24. The computing system of claim 23, wherein the logic is to cause a modification to at least one of the one or more sub-pulses to encode the plurality of light beam pulses.

25. The computing system of claim 23, wherein the logic is to detect a modification to at least one of the one or more sub-pulses to decode the plurality of light beam pulses.
